(19) United States
(12) Patent Application Publication
(10) Pub. No.: US 2006/0040039 A1
(43) Pub. Date: Feb. 23, 2006

(54) Composition comprising hemp and method for making

(75) Inventor: Trevis Lee Webb, Grants Pass, OR (US)

Correspondence Address: DEMONT & BREYER, LLC, SUITE 250, 100 COMMONS WAY, HOLMDEL, NJ, 07733, US

(73) Assignee: Joe Buzz, Inc., Grants Pass, OR (US)

(21) Appl. No.: 11/208,500

(22) Filed: Aug. 22, 2005

Related U.S. Application Data
(60) Provisional application No. 60/603,107, filed on Aug. 20, 2004.

(51) Int. Cl. A23L 2/00

(52) U.S. Cl. 426/590

(57) ABSTRACT

Beverage compositions that incorporate hemp are disclosed. In accordance with the illustrative embodiment of the present invention, ground roasted hemp is prepared, and is then used as an ingredient in any of a variety of compositions that are suitable for human consumption.

### STATEMENT OF RELATED CASES

This case claims priority of U.S. Provisional Patent Application No. 60/603,107, filed Aug. 20, 2004.

### FIELD OF THE INVENTION

The present invention relates to beverage compositions.

### BACKGROUND OF THE INVENTION

It is not unusual to see three or more coffee houses within a few hundred feet of one another along main thoroughfares in destination cities. This proliferation of coffee houses has spurred the sale of premium specialty coffees and related products such as Chai tea, blended coffee drinks, and the like.

But the same specialty drinks using the same flavor additives—chocolate, caramel, amaretto-flavoring, etc.—are available seemingly everywhere. The names might change, but the drinks are basically the same.

A new beverage offering, which is suitable for sale at coffee houses and at any location at which coffee-type products are sold, would enable a retailer to distinguish itself and provide the consumer with an alternative to the coffee and tea beverages now available.

### SUMMARY OF THE INVENTION

The present invention provides beverage compositions that incorporate hemp. In accordance with the illustrative embodiment of the present invention, ground roasted hemp is prepared, and is then used as an ingredient in any of a variety of compositions that are suitable for human consumption.

For example, in some embodiments, ground roasted hemp is added to a commercial espresso maker to prepare a “hemp shot.” The hemp shot can then be added to any of a variety of liquids (e.g., milk, soy, plain coffee, cappuccino, espresso, etc.) to produce any of a variety of hemp-containing drinks.

In some other embodiments, ground roasted hemp is added to ground coffee and then added to a coffee machine to produce “hemp coffee.”

### DETAILED DESCRIPTION

The illustrative embodiment of the present invention is a composition comprising hemp and a method for producing the composition.

A composition in accordance with the illustrative embodiment includes ground roasted hemp. A minimum roasting time is required to sterilize the hemp. This minimum is about 2 minutes.

Once the minimum roasting time is achieved, a longer roast generally gives a lighter flavor while a longer roast gives a bolder, richer flavor. Time and temperature can be traded off; that is, roasting at a relatively higher temperature enables a decrease in roasting time for a given roast. Variation in other roasting conditions will result in differences in flavor in the roasted hemp.

Nominal roasting conditions for raw industrial hemp seeds are 350 degrees F. for 14 minutes in a drum-style roaster. In some alternative embodiments, the hemp seeds are roasted at different temperatures (e.g., 275 to 425 F) and for a different amount of time (e.g., 2 to 20 minutes).

The roasted hemp is then ground. Hemp is very oily and not easily ground. In accordance with the illustrative embodiment, the roasted hemp is ground to a near-espresso consistency. This can be done using hand grinders or with machine grinders, such as a roller-style grinder, available from Modern Process Equipment of Chicago, Ill. The roller-style grinder chips the hemp seed, rather than crushes it, as would occur in a typical coffee grinder. If a crushing-type machine grinder were used to grind hemp, an undesirable peanut butter-like consistency results. After grinding, the hemp is sifted to remove any large seed particles.

After grinding, the roasted hemp is ready for use as an ingredient in any of a variety of compositions that are suitable for human consumption as beverages.

Composition 1: Hemp Latte

Using a double hepo-filter, the ground roasted hemp is added to a commercial espresso maker. A tamper is used to pack the ground roasted hemp very tightly, since, if the hemp is ground by hand, it will not be as finely ground as (machine-ground) espresso. In embodiments in which the roasted hemp is machine ground, the filter of the espresso maker is packed as would be done for espresso. A two ounce “double” shot is pulled through the espresso maker. For best taste, spring water is advantageously used in the espresso machine. As used herein, the term “hemp shot” means the liquid composition that results when ground roasted hemp is added to an espresso maker and combined with water within the espresso maker.

For a 12 ounce drink, the hemp latte includes:
2.0 ounces (i.e., a “double” shot) of hemp, as produced above;
9.5 ounces of low fat soy milk that is frothed to near boiling; and
0.5 ounces of vanilla syrup.

Low fat soy milk is commercially available under the trademark Select Soy® from Pacific Foods of Tualatin, Oreg., among others, and vanilla syrup is available under the trademark Torani® from R Torre and Co., among others. In some alternative embodiments, dairy products such as cream, half & half, milk (whole, low fat, skim, etc.) are used in place of soy milk. Also, to reduce the carbohydrate content of the drink, especially when using a dairy product, the vanilla syrup can be omitted.

Composition 2: Hemp Coffee

Ground roasted hemp, produced as described above, is added to coffee. In a preferred embodiment, hemp and coffee are present in a 1:1 volumetric ratio in hemp-coffee mixture. In some other embodiments, the ratio of hemp to coffee is different. Typically, for these alternative embodiments, the hemp-to-coffee ratio will be in a range of about 0.5:1.0 to about 2.0:1.0 on a volumetric basis. Of course, as suits individual tastes, the ratio for hemp coffee can vary from >99% hemp and <1% coffee to <1% hemp and >99% coffee. The hemp-coffee mixture is then used to produce hemp coffee via a coffee maker.

Composition 3: Coffee Drink with Hemp Shot

A shot of hemp, as obtained from an espresso machine as described above, is added to any coffee drink (e.g., plain coffee, cappuccino, espresso, iced coffee drinks, etc.).

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

What is claimed is:

1. A composition comprising:
a hemp shot; and
at least one fluid selected from the group consisting of low fat soy milk, soy milk, cream, milk, and a coffee drink.

2. The composition of claim 1 wherein said hemp shot comprises about two ounces.

3. The composition of claim 2 wherein said fluid comprises about 9.5 ounces of low fat soy milk.

4. The composition of claim wherein said fluid comprises low fat soy milk.

5. The composition of claim 4 further comprising vanilla syrup.

6. A method comprising roasting raw industrial hemp seeds at a temperature in a range of about 275° F. to about 425° F. for an amount of time between about 2 and 20 minutes.

7. The method of claim 6 wherein said temperature is about 350° F.

8. The method of claim 7 wherein said time is about 14 minutes.

9. The method of claim 6 wherein said hemp seeds are roasted in a drum-style roaster.

10. The method of claim 6 further comprising grinding said hemp after said roasting.

11. The method of claim 10 further comprising mixing said hemp with ground coffee after said grinding.

12. The method of claim 11 wherein a ratio of said hemp to said ground coffee is about 1:1 on a volumetric basis.

13. The method of claim 11 wherein a ratio of said hemp to said ground coffee is in a range of about 0.5:1.0 to about 2.0:1.0 on a volumetric basis.
